(19) United States
(12) Patent Application Publication
(10) Pub. No.: US 2017/0283999 A1
(43) Pub. Date: Oct. 5, 2017

(54) CURLING RIBBON FOR DECORATING GIFTS

(71) Applicant: Goldina Loy GmbH & Co. KG, Landsberg am Lech (DE)

(72) Inventor: Till Hackenberg, Munich (DE)

(21) Appl. No.: 15/477,489

(22) Filed: Apr. 3, 2017

(30) Foreign Application Priority Data
Apr. 5, 2016 (DE) 20 2016 002 170.3

(51) Int. Cl. D04D 9/04; B32B 27/10; D04D 7/04; B32B 29/06; B44C 1/10; B32B 27/32; B32B 7/12

(52) U.S. Cl. CPC D04D 9/04; B32B 27/32; B32B 27/10; B32B 7/12; B32B 29/06; B44C 1/105; D04D 7/04; B32B 2307/51; B32B 2553/00; B32B 2250/40; B32B 2250/03

(57) ABSTRACT

The invention relates to a curling ribbon for decorating gifts, which has a flat shape and includes two opposed parallel outer surfaces, wherein the ribbon according to the invention is of layered construction and includes a carrier layer made of plastic material, wherein at least one surface of the carrier layer is laminated with a covering layer of paper.

The present invention relates to a curling ribbon for decorating gifts.

Curlable gift ribbons are known. These are mostly colored, decorative ribbons with which gifts are decorated.

It is the object of the invention to provide a curlable gift ribbon which opens up new design possibilities.

Against this background the invention relates to a curling ribbon with a flat shape and two opposed parallel outer surfaces, wherein the ribbon is of layered construction and includes a carrier layer of plastic material. At least one surface of the carrier layer is laminated with a covering layer of paper.

In one embodiment the surface of the covering layer represents the outer surface of the ribbon. Hence the covering layer is responsible for the optical appearance of the ribbon and provides the ribbon with a paper-like appearance, while the carrier layer is responsible for the tear strength and the knottability of the ribbon. Both the carrier layer and the covering layer can have curlable properties, wherein the same typically are formed more strongly for the carrier layer. Curlable properties here are understood to be the property of the generally flat ribbon of curling after a tensile elongation and a partially elastic rebound. The tensile elongation can be effected in a known way by drawing over a sharp edge such as the cutting edge of a pair of scissors.

In one embodiment the carrier layer consists of polypropylene. This material can be manufactured at low cost and can have a suitable elasticity profile.

In one embodiment the carrier layer has a thickness of less than 0.2 mm. For example, thicknesses of 0.1-0.15 mm are advantageous, in order to ensure an optimum stability.

In one embodiment the carrier layer has elastic material properties, so that the carrier layer at least partly contracts again after an elongation.

In one embodiment the covering layer consists of paper, preferably of kraft paper or soda kraft paper.

In one embodiment the paper of the covering layer is printed in color and in particular in a single color. The ribbon thus can adopt a particular color or be provided with a particular design by simple printing of paper, without the carrier layer of plastic material having to be dyed.

In one embodiment the paper of the covering layer has a basis weight of 50-100 g/m². There can be used commercially available kraft papers. Due to this basis weight the ribbon is provided with a high-quality character and the paper-like appearance and haptics are underlined.

In one embodiment the covering layer is glued onto the carrier layer. This provides for a particularly easy manufacture of the ribbon.

In one embodiment both surfaces of the carrier layer are laminated with a covering layer of paper. All aspects described so far for a covering layer in this case are possible on both covering layers.

Further details and advantages of the invention can be taken from the exemplary embodiment described below with reference to the Figures. In the Figures:

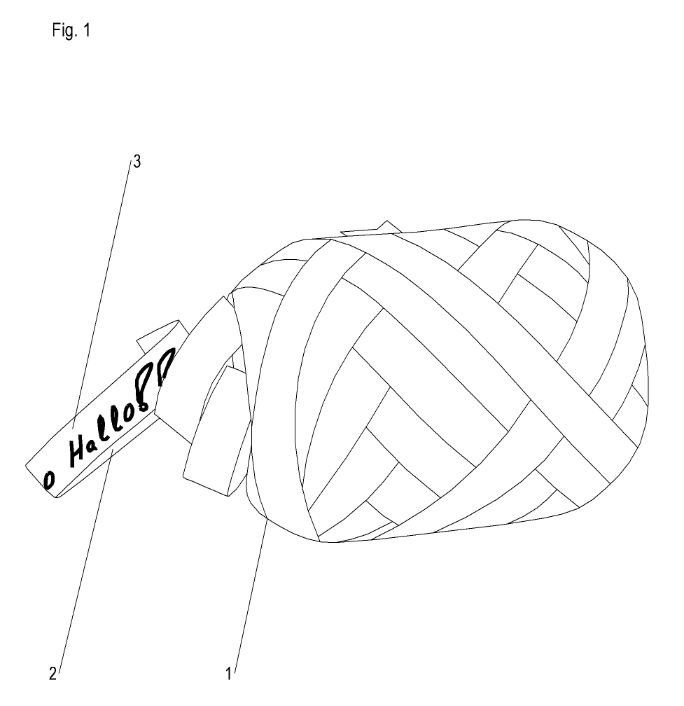

FIG. 1: shows a roll of a curling ribbon according to the invention; and

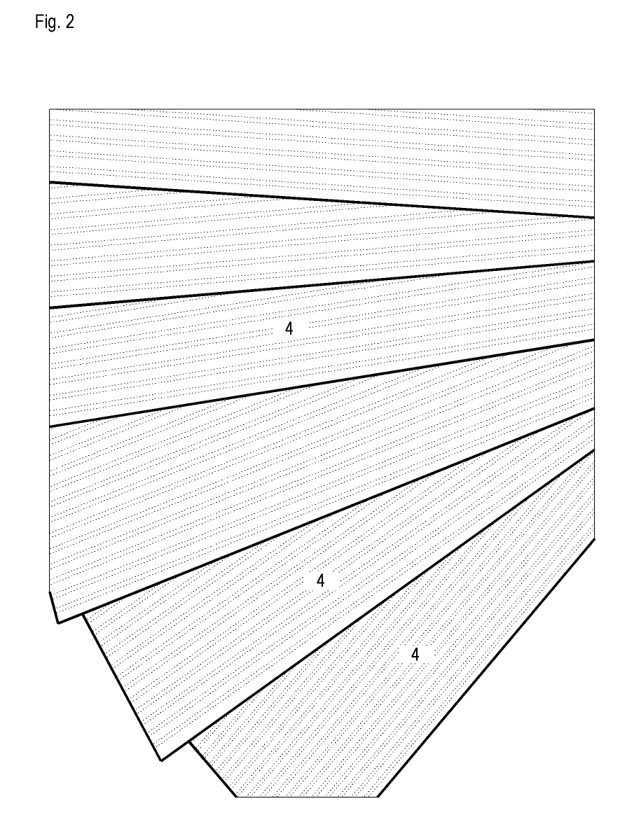

FIG. 2: shows different sheets of paper-coated plastic films from which a curling ribbon according to the invention can be cut.

FIG. 1 shows a curling ribbon 1 according to the invention for decorating gifts. The ribbon 1 has an oblong and flat shape and includes two opposed surfaces 2 and 3 which extend parallel to each other.

The ribbon 2 comprises two layers, wherein a carrier layer of elastic propylene with a thickness of 125 μm is unilaterally coated with a covering layer of soda kraft paper with a basis weight of between 60 and 80 g/m², so that the ribbon altogether has a paper-like appearance, while due to the carrier layer it can curl after a tensile elongation over a scissors edge and partially elastic rebound.

In one embodiment the paper of the covering layer is printed with color. The ribbon thus can adopt a particular color or be provided with a particular design by simple dying or printing of paper, without the carrier layer of plastic material having to be dyed.

During the manufacture a film of propylene is unilaterally laminated with kraft paper and glued, so that a sheet 4 of paper-like appearance is obtained, which is shown in FIG. 2 and advantageously is very long or endless. From this sheet 4 strips having the width of the ribbon 2 can then be cut, in order to manufacture the ribbon according to the invention in a simple way. The paper for example can be printed in a single color, in order to provide the ribbon 2 with the desired appearance.

The ribbon has the appearance of paper, in the illustrated example kraft paper, but can be knotted in contrast to pure paper ribbons. The product looking like paper only then can be used as gift ribbon. The particularity of the product consists in producing a ribbon which according to its appearance and haptics is a paper product, but has the properties of a gift ribbon (curling ribbon).

1. A curling ribbon for decorating gifts, which has a flat shape and includes two opposed parallel outer surfaces, wherein the ribbon is of layered construction and includes a carrier layer of plastic material, and at least one surface of the carrier layer is laminated with a covering layer of paper.

2. The packaging ribbon according to claim 1, wherein the surface of the covering layer represents the outer surface of the ribbon.

3. The packaging ribbon according to claim 1, wherein the carrier layer consists of polypropylene.

4. The packaging ribbon according to claim 1, wherein the carrier layer has a thickness of less than 0.2 mm.

5. The packaging ribbon according to claim 1, wherein the carrier layer is elastic.

6. The packaging ribbon according to claim 1, wherein the paper of the covering layer is kraft paper or soda kraft paper.

7. The packaging ribbon according to claim 1, wherein the paper of the covering layer is printed in color and in particular in a single color.

8. The packaging ribbon according to claim 1, wherein the paper of the covering layer has a basis weight of 50-100 g/m².

9. The packaging ribbon according to claim 1, wherein the covering layer is glued onto the carrier layer.

10. The packaging ribbon according to claim 1, wherein both surfaces of the carrier layer are laminated with a covering layer of paper.

11. The packaging ribbon according to claim 2, wherein the carrier layer consists of polypropylene.

12. The packaging ribbon according to claim 11, wherein the carrier layer has a thickness of less than 0.2 mm.

13. The packaging ribbon according to claim 3, wherein the carrier layer has a thickness of less than 0.2 mm.

14. The packaging ribbon according to claim 2, wherein the carrier layer has a thickness of less than 0.2 mm.

15. The packaging ribbon according to claim 14, wherein the carrier layer is elastic.

16. The packaging ribbon according to claim 13, wherein the carrier layer is elastic.

17. The packaging ribbon according to claim 12, wherein the carrier layer is elastic.

18. The packaging ribbon according to claim 11, wherein the carrier layer is elastic.

19. The packaging ribbon according to claim 4, wherein the carrier layer is elastic.

20. The packaging ribbon according to claim 3, wherein the carrier layer is elastic.
